(19) United States
(12) Patent Application Publication
(10) Pub. No.: US 2009/0000711 A1
(43) Pub. Date: Jan. 1, 2009

(54) Rubber mixture and tires

(75) Inventors: Christian Strubel, Hannover (DE); Dietmar Sohnen, Lauenau (DE)

Correspondence Address: COLLARD & ROE, P.C., 1077 NORTHERN BOULEVARD, ROSLYN, NY, 11576, US

(73) Assignee: CONTINENTAL AKTIENGESELLSCHAFT

(21) Appl. No.: 12/231,464

(22) Filed: Sep. 3, 2008

Related U.S. Application Data
(63) Continuation of application No. PCT/EP2007/052780, filed on Mar. 23, 2007.

(30) Foreign Application Priority Data
May 23, 2006 (DE) 10 2006 024 035.9

(51) Int. Cl. B60C 11/00; C08L 25/10; C08K 5/01

(52) U.S. Cl. 152/209.1; 525/192; 525/194; 524/525

(57) ABSTRACT

The invention relates to a sulfur-cross-linkable rubber mixture, which contains 20-80 phr of at least one solution polymerized styrene-butadiene copolymer A, whose end groups at least are chemically modified with a nitrogen containing compound, and 20-80 phr of at least one other solution polymerized styrene-butadiene copolymer B, which has coupling centers with epoxide groups, in particular for good tire properties and good breaking behavior.

The invention relates to a sulfur-crosslinkable rubber mixture, in particular for the tread of pneumatic vehicle tires, containing solution-polymerized styrene butadiene copolymers. The invention furthermore relates to a pneumatic vehicle tire having a tread which at least partly comprises such a sulfur-vulcanized rubber mixture.

Since the driving properties of a tire, in particular of a pneumatic vehicle tire, are dependent to a large extent on the rubber composition of the tread, the composition of the tread mixture is subject to particularly high requirements. Thus, a variety of tests have been carried out to positively influence the properties of the tire by varying the polymer components, the fillers and the other additives in the tread mixture. It is necessary thereby to take into account that an improvement in one tire property often results in a deterioration in another property. Tread mixtures for car and van tires, for example have to meet very high requirements with regard to ABS braking under wet and dry conditions, the braking resistance, rolling resistance, durability and handling, in particular on a dry roadway. The dynamic rigidity serves as a measure of the handling behavior on a dry roadway, it being possible to correlate an increase in the dynamic rigidity or in the dynamic modulus E′ with an improvement in the handling behavior.

A possibility for improving the braking behavior on a wet and dry roadway consists in reducing the hardness (static rigidity) of the tread mixture, for example by increasing the proportion of plasticizer. Since dynamic and static rigidity generally change in the same direction within a mixture system (i.e. both are increased or both are reduced), this results at the same time in a reduction in dynamic rigidity, which is equivalent to deteriorations in the handling behavior. Thus, by this approach, the braking behavior can be improved only at the expense of the handling behavior.

In order to influence tire properties, such as abrasion, wet slip behavior and rolling resistance, for example, the use of various styrene-butadiene copolymers having different styrene and vinyl contents and having different modifiers for the rubber mixtures is known.

EP 1 270 657 A1 discloses improving the properties of a tire with regard to wet grip, winter properties, abrasion and rolling resistance by using, for the rubber mixture which forms the tire tread, 30-90 phr of a solution-polymerized styrene-butadiene copolymer (S-SBR) which has a styrene content of from 5 to 35% by weight and a vinyl fraction of 10-85% by weight. The S-SBR is coupled, for example to tin, and is chemically modified with an amino group. The rubber mixture also contains 10-70 phr of at least one further diene rubber, from 20 to 200 phr of silicon, 1-15 phr of a silane coupling agent and 5-60 phr of a special plasticizer. The handling potential of the tire mixtures as mentioned in EP 1 270 657 A1 in any case does not correspond to the desired high requirements.

EP 1 457 501 A1 discloses styrene-butadiene copolymers, which have a high proportion of vinyl and are modified with primary amino groups and alkoxy silyl groups, processes for the preparation of these styrene-butadiene copolymers, rubber mixtures comprising these styrene-butadiene copolymers and tires whose treads consist of this rubber mixture. The tires are said to be distinguished by a good balance between abrasion resistance, durability, hysteresis loss and wet grip behavior.

EP 1 153 972 A1 describes rubber mixtures for tire treads, which mixtures contain styrene-butadiene copolymers having coupling centers with epoxide groups, optionally further diene rubbers, plasticizer oil, silica and vulcanizing agent. The coupling centers are within the polymer backbone and are not present as terminal groups. The rubber mixtures exhibit good processability and are said to give rise to low rolling resistance in combination with good wet grip in the tire.

Starting from this prior art, it is the object of the invention to provide rubber mixtures for the treads of pneumatic vehicle tires, the vulcanizates of which are distinguished by increased dynamic rigidity and hence improve the customer-relevant property “handling on a dry road”, it being intended at the same time for the hardness (static rigidity) to remain at the same level or even to be reduced in order to produce good braking behavior in tires.

This object is achieved, according to the invention, if the rubber mixture contains
20-80 phr (parts by weight, based on 100 parts by weight of the total rubbers in the mixture) of at least one solution-polymerized styrene-butadiene copolymer A whose terminal groups are chemically modified at least by a nitrogen-containing compound, and
20-80 phr of at least one further solution-polymerized styrene-butadiene copolymer B which has coupling centers with epoxide groups.

The phr (parts per hundred parts of rubber by weight) data used in this document are the amounts usually stated in the rubber industry for mixture formulations.

The metering of the parts by weight of the individual substances is always based on 100 parts by weight of the total mass of all rubbers present in the mixture. In the rubber industry, coupling is understood as meaning the stable linking of polymer chains to give branch structures in the unvulcanized state.

Surprisingly, it was found that, by the combination of from 20 to 80 phr of the terminal group-modified solution-polymerized styrene-butadiene copolymer A with from 20 to 80 phr of a further solution-polymerized styrene-butadiene copolymer B which has epoxide groups at the coupling centers within the polymer, the behavior of dynamic and static rigidity can be decoupled so that very high dynamic rigidities of the vulcanizates can be achieved in combination with relatively low static rigidities. In this way, with the use of the mixture as a tire tread, both the wet and dry braking behavior and the handling properties of the tire can be improved. The decoupling of the dynamic and static rigidity could be caused by interactions of the different modification groups of the solution-polymerized styrene-butadiene copolymers (terminal group modification with nitrogen-containing compounds—coupling centers with epoxide groups).

The solution-polymerized styrene-butadiene copolymers A and B used in the rubber mixture preferably have a vinyl fraction of 25-70% by weight and a styrene fraction of 10-40% by weight.

According to a preferred further development of the invention, the terminal groups of the solution-polymerized styrene-butadiene copolymer A are chemically modified with at least one substance selected from the group consisting of aminoaldehydes, aminoketones, aminothioaldehydes, aminothioketones and organic substances which have a structural building block

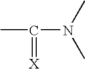

where X=O or S, in their molecule. An amino benzophenone is particularly preferably used for the chemical terminal group modification.

In addition to the terminal group modification with nitrogen-containing compounds, the solution-polymerized styrene-butadiene copolymer A used may additionally also have other terminal groups, e.g. alkoxy silyl groups, and, for example, may be coupled to tin. For example, so-called HPR types from JSR Corporation, whose preparation is disclosed, for example in EP 1 457 501 A1, or NS 116 R from Nippon Zeon (cf. e.g. U.S. Pat. No. 4,616,069) can be used as solution-polymerized styrene-butadiene copolymers A.

All types having epoxide groups at the coupling centers can be used as solution-polymerized styrene-butadiene copolymer B, for example the types E10 E15, E50, E60 or L233S from Asahi (also see EP 1 153 972 A1), which additionally have amino functionalities through the epoxide used for the coupling, or KA 8955 from Lanxess.

In addition to said solution-polymerized styrene-butadiene copolymers A and B, the rubber mixture according to the invention may contain further rubbers, such as, for example, styrene-isoprene-butadiene terpolymer, butyl rubber, halobutyl rubber or ethylene-propylene-diene rubber (EPDM). However, it is preferable if the rubber mixture contains from 5 to 50 phr of at least one further diene rubber selected from the group consisting of natural rubber (NR), synthetic polyisoprene (IR), polybutadiene (BR) and other styrene-butadiene copolymers (SBR). These diene rubbers can readily be processed to give the rubber mixture and, in the vulcanized tires, result in good tire properties.

The rubber mixture may contain polyisoprene (IR, NR) as the diene rubber. This may be both cis-1,4-polyisoprene and 3,4-polyisoprene. However, the use of cis-1,4-polyisoprenes having a cis-1,4 fraction>90% by weight is preferred. Firstly, such a polyisoprene can be obtained by stereo specific polymerization in solution using Ziegler-Natta catalysts or using finely divided alkyllithiums. Secondly, natural rubber (NR) is such a cis-1,4-polyisoprene; the cis-1,4 fraction in the natural rubber is greater than 99% by weight.

If the rubber mixture contains polybutadiene (BR) as the diene rubber, this may be both cis-1,4- and vinyl-polybutadiene (40-90% by weight vinyl fraction). The use of cis-1,4-polybutadiene having a cis-1,4 fraction of greater than 90% by weight, which can be prepared, for example, by solution polymerization in the presence of catalysts of the rare earth type, is preferred.

The other styrene-butadiene copolymers are those which are not covered by the specially modified solution-polymerized types as claimed in claim 1. These may be, for example, unmodified or differently modified or coupled solution-polymerized styrene-butadiene copolymers. However, it is also possible to use emulsion-polymerized styrene-butadiene copolymers (E-SBR) and mixtures of E-SBR and S-SBR. The styrene content of the E-SBR is from about 15 to 50% by weight, and it is possible to use the types which are known from the prior art and were obtained by copolymerization of styrene and 1,3-butadiene in an aqueous emulsion.

For further improvement of the dynamic rigidity, the rubber mixture contains 20- 100 phr, preferably 50-90 phr, of at least one silica and 1- 15 phr of at least one silane coupling agent. The terminal groups and coupling centers of the solution-polymerized styrene-butadiene copolymers A and B appear to undergo an advantageous interaction with the polar groups of the silica and of the silane coupling agent. All silicas known to persons skilled in the art for the tire industry may be used.

The silane coupling agents simultaneously serve for improving the processability and for binding the silica and any other polar fillers present to the diene rubber and react with the surface silanol groups of the silica or other polar groups during the mixing of the rubber or of the rubber mixture (in situ) or even before the addition of the filler to the rubber in the manner of a pretreatment (premodification). Silane coupling agents which may be used are all silane coupling agents known to the person skilled in the art for use in rubber mixtures. Such coupling agents known from the prior art are bifunctional organosilanes which have at least one alkoxy, cycloalkoxy or phenoxy group as a leaving group on the silicon atom and which have, as another functionality, a group which, if appropriate after cleavage, may undergo a chemical reaction with the double bonds of the polymer. The last-mentioned group may be, for example, the following chemical groups: - SCN, —SH, —NH₂ or —Sₓ- (where x=2-8). Thus, for example, 3-mercaptopropyltriethoxy silane, 3-thiocyanato propyltrimethoxy silane or 3,3′-bis(triethoxysilylpropyl)polysulfides having 2 to 8 sulfur atoms, for example 3,3′-bis(triethoxysilylpropyl)tetrasulfide (TESPT), the corresponding disulfide or mixtures of the sulfides having 1 to 8 sulfur atoms with different contents of the various sulfides may be used as silane coupling agents. TESPT can also be added, for example, as a mixture with industrial carbon black (X50S from Degussa).

In addition to silica, the rubber mixture may also contain further fillers, such as aluminum hydroxide, phyllosilicates, chalk, starch, magnesium oxide, titanium dioxide, rubber gels, short fibers, etc., in any desired combinations. However, it preferably contains from 5 to 35 phr of carbon black.

From the ecological point of view, it is advantageous if the rubber mixture is free of aromatic process oils. Aromatic process oils are understood as meaning mineral oil plasticizers which, according to ASTM D 2140, contain more than 25%, preferably more than 35%, of aromatic constituents (C_{A}), less than 45% of naphthenic constituents (C_{N}) and less than 45% of paraffinic constituents (C_{P}). The viscosity-gravity constant according to ASTM D 2140 (VGC) of aromatic process oils is greater than 0.9. Furthermore, the aromatic process oils are classified according to ASTM D 2226 as oil type 101 and 102.

Instead of the aromatic process oils, preferably 1-80 phr, preferably 3-30 phr, of at least one mineral oil plasticizer which has a content of polycyclic aromatic compounds, determined with the DMSO extract according to the IP 346 method, of less than 3% by weight, based on the total weight of the mineral oil plasticizer, are used. The polycyclic aromatic compounds comprise aromatic hydrocarbons which contain more than three condensed aromatic rings and the aromatic compounds derived therefrom and comprising sulfur and/or nitrogen. The rings may be substituted by short alkyl or cycloalkyl groups.

The amount of 1-80 phr, preferably 5-30 phr, of a mineral oil plasticizer or combinations of a plurality of mineral oil plasticizers ensures optimum processibility in combination with good dynamic properties and low-temperature flexibility.

As mineral oil plasticizers whose contents of polycyclic aromatic compounds (PCA content), determined with the DMSO extract according to the IP 346 method, are less than 3% by weight, based on the total weight of the mineral oil plasticizer, it is possible in principle to use all mineral oil plasticizers which are known to the person skilled in the art and fulfill these values. Such mineral oil plasticizers are, for example, MES (mild extraction solvate), which is obtained by solvent extraction of heavy oil distillates or by treatment of heavy oil distillates with hydrogen in the presence of a catalyst (hydrogenation), TDAE (treated destillate aromatic extract) or naphthenic plasticizers. Regarding these mineral oil plasticizers, reference may be made in this context by way of example to V. Null, “Safe Process Oils for Tires with Low Environmental Impact”, Kautschuk Gummi Kunstoffe, 12/1999, pages 799-805. The use of such mineral oil plasticizers in rubber mixtures is also disclosed, for example, in EP 0 940 462 A2. If a mineral oil plasticizer having a glass transition temperature of less than −45° C. is used, the low-temperature flexibility at lower temperatures can be further improved.

In addition to the abovementioned ingredients, the rubber mixture may contain further additives customary in the rubber industry, such as, for example, further plasticizers, antiaging agents, activators, such as, for example, zinc oxide and fatty acids (e.g. stearic acid), waxes and mastication auxiliaries, in customary parts by weight.

The vulcanization is carried out in the presence of sulfur or sulfur donors, it being possible for some sulfur donors simultaneously to act as vulcanization accelerators. Sulfur or sulfur donors are added to the rubber mixture in the last mixing step in the amounts customary for the person skilled in the art (from 0.4 to 4 phr, sulfur preferably in amounts of from 1.5 to 2.5 phr).

Furthermore, the rubber mixture may contain vulcanization-influencing substances, such as vulcanization accelerators, vulcanization retardants and vulcanization activators in customary amounts in order to control the required time and/or the required temperature of the vulcanization and to improve the vulcanizate properties. The vulcanization accelerators can be selected, for example, from the following accelerator groups: thiazole accelerators, such as, for example, 2-mercaptobenzothiazole, sulfenamide accelerators, such as, for example, benzothiazyl-2-cyclohexylsulfenamide (CBS), guanidine accelerators, such as, for example, N,N-′diphenylguanidine (DPG), dithiocarbamate accelerators, such as, for example, zinc dibenzyldithiocarbamate, disulfides. The accelerators can also be used in combination with one another, it being possible to obtain synergistic effects.

The rubber mixture according to the invention is prepared in a conventional manner, first, as a rule, a base mixture which contains all constituents with the exception of the vulcanization system (sulfur and vulcanization-influencing substances) being prepared in one or more mixing stages and the final mixture being produced thereafter by addition of the vulcanization system. The mixture is then further processed, for example by an extrusion process, and introduced into the corresponding mold. Preferably, the mixture is introduced into the mold of a tread. A tread mixture blank thus produced is applied in a known manner in the production of the pneumatic vehicle tire blank. The tread can, however, also be wound in the form of a narrow rubber mixture strip onto a tire blank which already contains all tire parts except for the tread. In the case of the tires, it is unimportant whether the entire tread has been produced from a single mixture or has, for example, a cap- and base structure; what is important is that at least the surface coming into contact with the carriageway has been produced from the rubber mixture according to the invention.

The invention is now to be explained in more detail with reference to comparative and working examples, which are summarized in table 1.

In the case of all mixture examples present in table 1, the stated amounts are parts by weight which are based on 100 parts by weight of total rubber (phr). The comparative mixtures are characterized by C and the mixture according to the invention is characterized by I. The mixtures were adjusted to have the same hardness. It should be noted that the S-SBR B is a type extended with aromatics-free oil. 100 parts by weight of rubber were extended with 37.5 parts by weight of oil (oil content: 27.3%). If the oil is eliminated from the calculation, the proportions of rubber sum as usual to 100.

The mixtures according to table 1 were used to produce tires whose treads consist of said mixtures. Comparative tests was carried out with these tires with regard to the ABS braking under wet conditions, the ABS braking under dry conditions, the rolling resistance and the abrasion. The properties of the tire having a tread comprising a mixture according to 1(C) were set equal to 100. Values greater than 100. denote an improvement in the corresponding property (rating). Furthermore, the Shore A hardness at room temperature according to DIN 53 505 and the dynamic modulus E′ (dynamic rigidity) were determined as a function of the elongation (0.1-12%) at constant temperature for the mixtures in the laboratory. For this purpose, the mixture was prepared under customary conditions in two stages in a laboratory tangential mixer. Test specimens were produced from the mixtures by optimum vulcanization under pressure at 160° C., and the Shore A hardness and the dynamic modulus E1, which permits conclusions about the handling behavior on a dry carriageway, were determined with these test specimens.

TABLE 1

| Constituent | Unit | 1 (C) | 2 (C) | 3 (I) |
|---|---|---|---|---|
| Natural rubber | phr | 30 | 30 | 30 |
| S-SBR type A^{a} | phr | 70 | — | 40 |
| S-SBR type B, oil extended^{b} | phr | — | 96.25 | 41.25 |
| Carbon black N-339 | phr | 10 | 10 | 10 |
| Silica^{c} | phr | 85 | 85 | 85 |
| TDAE^{d} | phr | 30 | 3 | 13 |
| Silane coupling agent^{e} | phr | 8 | 8 | 8 |
| Antiaging agent | phr | 4 | 4 | 4 |
| Zinc oxide | phr | 2 | 2 | 2 |
| Stearic acid | phr | 1 | 1 | 1 |
| Accelerator | phr | 4 | 4 | 4 |
| Sulfur | phr | 1.7 | 1.7 | 1.7 |
| Tire property | | | | |
| ABS braking under dry | | 100 | 101 | 101 |
| conditions | | | | |
| ABS braking under wet | | 100 | 107 | 105 |
| conditions | | | | |
| Rolling resistance | | 100 | 92 | 94 |
| Abrasion | | 100 | 85 | 95 |
| Hardness | Shore A | 69 | 69 | 69 |
| Dynamic modulus E′ | MPa | 7.4 | 7.1 | 9.0 |

^{a}NS 116 R, Nippon Zeon, Japan, vinyl fraction: 63% by weight, styrene fraction: 21% by weight, tin-coupled and terminal group-modified with aminobenzophenone
^{b}L233S, Asahi, Japan, vinyl fraction: 53% by weight, styrene fraction: 32% by weight, comprising coupling centers with epoxide groups, oil-extended with 27.3% of aromatics-free oil
^{c}VN3, Degussa AG, Germany, nitrogen surface area: 175 m²/g, CTAB surface area: 160 m²/g
^{d}Treated destillate aromatic extract
^{e}Silquest ® A 1589, General Electric Speciality, USA

The data in the table showed that the dynamic rigidity of the vulcanizates can be greatly increased in a surprising manner by the special combination of the solution-polymerized styrene-butadiene copolymers A and B, without at the same time having to accept deteriorations in the hardness (static rigidity). With the use of this mixture as tire treads, this results in substantially improved handling behavior in combination with good braking behavior on a wet and dry carriageway, as also shown by the tire results in table 1.

1. A sulfur-crosslinkable rubber mixture, in particular for the tread of vehicle tires, containing:
20-80 phr (parts by weight, based on 100 parts by weight of the total rubbers in the mixture) of at least one solution-polymerized styrene-butadiene copolymer A whose terminal groups are chemically modified at least by a nitrogen-containing compound, and
20-80 phr of at least one further solution-polymerized styrene-butadiene copolymer B which has coupling centers with epoxide groups.

2. The rubber mixture as claimed in claim 1, wherein the solution-polymerized styrene-butadiene copolymers A and B have a vinyl fraction of 25-70% by weight and a styrene fraction of 10-40% by weight.

3. The rubber mixture as claimed in claim 1, wherein the terminal groups of the solution-polymerized styrene-butadiene copolymer A are chemically modified with at least one substance selected from the group consisting of aminoaldehydes, aminoketones, aminothioaldehydes, aminothioketones and organic substances which have a structural building block 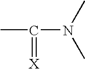
where X=0 or S, in their molecule.

4. The rubber mixture as claimed in claim 1, wherein it contains 5-50 phr of at least one further diene rubber selected from the group consisting of natural rubber, synthetic polyisoprene, polybutadiene and other styrene-butadiene copolymers.

5. The rubber mixture as claimed in claim 1, wherein it contains 20-100 phr, preferably 50-90 phr, of at least one silica and 1-15 phr of at least one silane coupling agent.

6. The rubber mixture as claimed in claim 1, wherein it contains 5-35 phr of carbon black.

7. The rubber mixture as claimed in claim 1, wherein it is free of aromatic process oils.

8. The rubber mixture as claimed in claim 1, wherein it contains 1-80 phr, preferably 3-30 phr, of at least one mineral oil plasticizer which has a content of polycyclic aromatic compounds, determined with the DMSO extract according to the IP 346 method, of less than 3% by weight, based on the total weight of the mineral oil plasticizer.

9. Rubber mixture as claimed in claim 1, wherein the mineral oil plasticizer is selected from the group consisting of naphthenic mineral oil plasticizers, MES (mild extraction solvate) and TDAE (treated distillate aromatic extract).

10. A pneumatic vehicle tire having a tread which at least partly comprises a sulfur-vulcanized rubber mixture as claimed in claim 1.
